(19) United States
(12) Patent Application Publication
(10) Pub. No.: US 2002/0140718 A1
(43) Pub. Date: Oct. 3, 2002

(54) Method of providing sign language animation to a monitor and process therefor

(75) Inventors: Yong Yan, Yorktown Heights, NY (US); Yun-Ting Lin, Ossining, NY (US)

Correspondence Address: Edward M. Weisz, Esq., Cohen, Pontani, Lieberman & Pavane, 551 Fifth Avenue, Suite 1210, New York, NY, 10176, US

(73) Assignee: Philips Electronics North America Corporation

(21) Appl. No.: 09/821,524

(22) Filed: Mar. 29, 2001

(51) Int. Cl. G06F 3/14

(52) U.S. Cl. 345/706

(57) ABSTRACT

A system and method for generating an animation video signal of sign language gestures corresponding to words in an audio/video signal for display on a monitor screen. A speech component is isolated from the audio/video signal and the spoken words in the speech signal are recognized. The spoken words are then used to identify sign language gestures which are mapped onto an animation model for generating an animation signal. The animation signal is used to animate a character icon stored in the monitor to display sign language gestures corresponding to the words of the speech signal.

### BACKGROUND OF THE INVENTION

1. Field of the Invention

The present invention is directed to a method and process of providing animation of a character symbol or icon to a monitor for producing sign language gestures corresponding to a speech signal.

2. Description of the Related Art

There are presently two basic techniques for communicating broadcast signals to the hearing impaired over display monitors, such as televisions or computer terminals. These techniques involve providing a text transcript of a spoken audio signal and/or a video stream displaying sign language gestures. The use of sign language is typically limited to so-called “open captioned” systems wherein, in the case of a television signal, for example, a separate video signal captures an image of a person “signing” an audio speech signal obtained from a main TV broadcast signal. The signal image is then broadcast, along with the main TV audio/video (A/V) signal and displayed on a designated monitor screen area of a recipient's tuner, e.g. television set. Such open captioned systems have certain drawbacks particularly because all viewers of the main TV signal will also receive the signing image. Moreover, the signing image in the form of a video stream detrimentally occupies a wide portion of the A/V signal bandwidth used for transmitting the main A/V signal.

Another technique for adopting standard mass media such as television for comprehension by the hearing impaired is by providing a text transcript of the speech component of an audio signal, e.g., derived from the audio component of an A/V television signal. These prior art techniques usually take the form of “close captions” wherein a text signal representative of the A/V signal speech component is decoded by a processor in the television set and then displayed as subtitles of the television screen. In some instances, programs are broadcast with subtitles thus alleviating the need for activating or employing a decoder. Although the bandwidth requirements for transmitting a text signal are significantly less than that of transmitting a video signal (e.g., a sign language image signal), it has certain other drawbacks. Particularly, a viewer must be literate and mature enough to read and comprehend the subtitles and must be capable of doing so simultaneously while viewing the main video picture.

Accordingly, a sign language animation system and method are desired as an alternative to and as an improvement over the prior art systems.

### SUMMARY OF THE INVENTION

The present invention is directed to a method and system of providing sign language animation images to a monitor screen simultaneously with the display of an audio/video signal. The method provides for mapping of a speech component of an audio signal to a sign language animation model to generate animation model parameters which correspond to sign language gestures. The model parameters are used to generate an animation signal which is then used to render an animation image on the monitor screen so that a sign language image corresponding to the speech component of the A/V signal is displayed to a monitor viewer simultaneously with the display of the video signal component. In a preferred embodiment, the speech signal is isolated from the audio signal component of the A/V signal at a transmitter station, e.g., a television broadcast station, and is mapped to a sign language animation model. The resulting animation model parameters are then transmitted along with the A/V signal to the monitor display whereupon a processor connected to the monitor generates the animation signal for rendering the animation image. In this manner only a coded non-video signal containing the model parameters need be transmitted as opposed to the transmission of a sign language video signal.

In another preferred embodiment, one of a plurality of animated character icons may be selected from a memory contained in the television monitor. The selected icon will then be animated by the animation model parameters to yield and display the sign language animation signal on the monitor display screen.

In accordance with another embodiment, extraction of a speech component from an audio signal of a received A/V signal is preformed by a processor located at, or as a component of, the monitor. The processor will extract the speech component of the audio signal, identify words contained in the speech component, and map the identified words to a sign language model to produce animation parameters which are then rendered on the monitor display screen. This embodiment allows receipt of a standard A/V signal by the monitor, with all necessary processing, extraction and rendering occurring at the monitor receiver.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are merely intended to conceptually illustrate the structures and procedures described herein.

### BRIEF DESCRIPTION OF THE DRAWINGS

In the drawings, wherein like character denote similar elements throughout the several views:

FIG. 1 is a block diagram of a sign language animation system in accordance with a preferred embodiment of the present invention;

FIG. 2a is a block diagram of an exemplary monitor used in the inventive system;

FIG. 2b is a representation of a monitor display screen; and

FIG. 3 is a flow chart of a method of the present invention.

### DETAILED DESCRIPTION OF THE PRESENTLY PREFERRED EMBODIMENTS

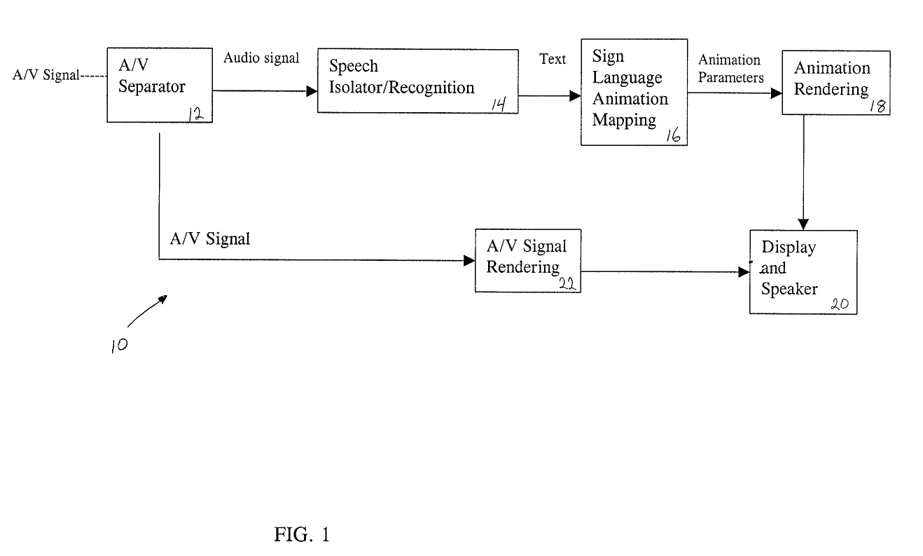

A block diagram of an exemplary embodiment of a system 10 for generating images of sign language gestures on a monitor screen is shown in FIG. 1. The system 10 utilizes a typical audio/video (A/V) signal as is generated from any number of sources, such as from a video cassette tape input to a monitor via a video cassette recorder, a digital video disk (DVD) input to a monitor by a DVD player, or from a television broadcast signal which is provided to multiple users via one or more of satellite, cable or aerial transmission as is known in the art. A/V signals can also be in the form of multimedia content accessible via the internet, such as content in Moving Pictures Experts Group (MPEG) format. Although the term “monitor” is discussed herein in terms of a television receiver set, it should be understood that in view of the various forms of A/V signals mentioned above all of which are capable of being used in the present invention, any type of A/V monitor may be employed such as a PC, laptop, hand-held computer device, etc.

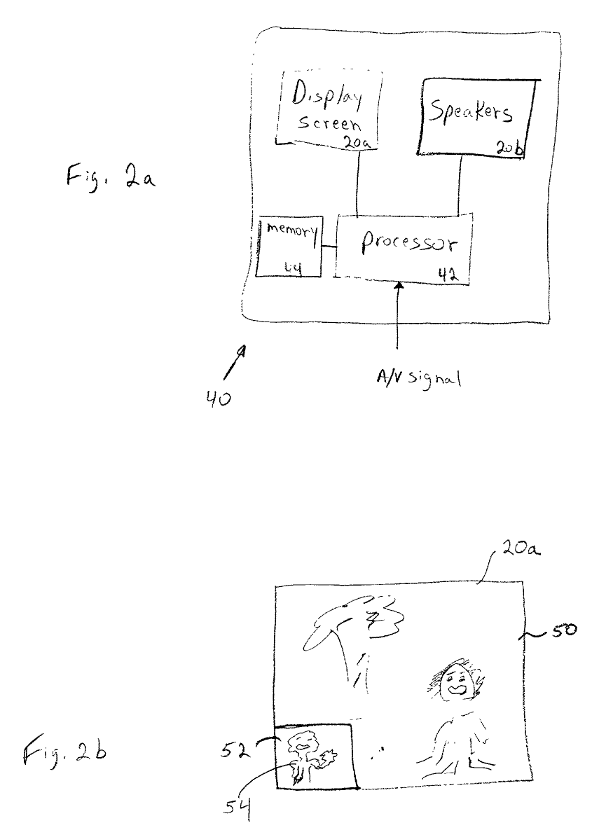

A typical A/V signal includes an audio component and a video component. The audio component includes sounds such as background noises, sound effects, etc., as well as speech or dialog, such as when a subject portrayed in the video component is speaking. In accordance with the present invention, a received A/V signal is to be displayed and output on a monitor display screen 20a of a monitor/receiver 40 (shown in FIG. 2a) in a known manner, e.g., by displaying the video component on the screen 20a and by broadcasting the audio component on a sound medium (i.e., speakers 20b connected to the monitor 40). Simultaneously with the display of the received A/V signal, and as explained more fully below, an animation signal of sign language gestures will be displayed, preferably on a portion of the monitor screen that does not significantly obstruct viewing of the audio signal component.

As shown in FIG. 1, an A/V separator block 12 is provided for separating or splitting an input A/V signal. The A/V separator 12 has at least two outputs. One of which passes the complete and unaltered A/V signal, and the other of which passes only the audio component thereof. This can be accomplished by using numerous prior art techniques, such as via a hardware or software implemented bandpass filter centered proximate an audio signal frequency spectrum. Once the audio component is separated from the A/V signal, a speech isolator/recognition block 14 is used to identify and isolate the speech component from the remainder of the audio signal (e.g., the background noise, sound effects, etc.). Various known techniques involving frequency analysis, pattern recognition and/or speech enhancement may be employed for this purpose. One such speech extraction device is the Speech Extraction System presently offered by Intelligent Device, Inc., of Baltimore, Maryland. Other techniques are described in Hirschman et al., “Evaluating Content Extraction From Audio Sources”, University of Cambridge, Department of Engineering, Proceedings of the ESCA ETRW Workshop, Apr. 19-20, 1999.

Upon isolation or extraction of the speech signal from the audio signal, a speech recognition engine is employed for identifying spoken words in the speech signal. This is accomplished using any one of various existing products, techniques, algorithms and/or systems, such as a product offered by Philips Electronics North America Corporation under the designation “FREESPEECH”.

Once the words from the speech signal are identified, the words are correlated or otherwise used to identify sign language symbols or gestures. The identifed signals are then used in an animation mapping block 16 to produce animation model parameters. The animation mapping block 16 may employ various know graphic models of sign language gestures and/or index pointers referencing a pre-stored visual sign language symbol dictionary/look-up table stored in a memory. An example of a suitable mapping technique is disclosed in Wilcox, S. 1994, “The Multimedia Dictionary of American Sign Language”, Proceedings of ASSETS Conference, Association of Computing Machinists.

Once the sign language symbols corresponding to the words in the speech signal are identified, the resulting signal contains animation model parameters which are used by an animation rendering block 18 to manipulate or animate or otherwise impart movement to the features of a character or icon or symbol stored in memory in the monitor 40 to display the resulting sign language animation video signal on the monitor display screen 20a. In particular, it is presently preferred that the Body Definition Parameters (BDP) and/or Body Animation Parameters (BAP) defined in a Synthetic Natural Hybrid Coding (SNHB) scheme of an MPEG-4 system be used to perform the sign language mapping, as will be known by those have ordinary skill in the art. The animation rendering unit 18 will then access a pre-stored model of a character icon to animate the icon on the display screen 20a to produce an animation of the icon executing sign language gestures corresponding to the words identified in the speech signal. It should be appreciated that in addition to the generated animation sign language signal, the A/V signal will be rendered via block 22, in a known manner to reproduce the video component on the monitor display screen 20a and the sound component on one or more speakers 20b.

As shown in FIG. 2b, the display screen 20a is divided into two regions such as by using known picture-in-picture techniques to define a main screen portion 50 depicting an image of the main video component of the A/V signal and a signing window 52 wherein an animated icon or character 54 is contained. The character 54 will include one or more hands to convey sign language gestures to a viewer, and may also include a mouth which may be animated to simulate speaking, e.g. to allow a viewer to read the “lips” of the character to interpret the speech signal.

It is preferred that the parameters and software coding needed for character manipulation and animation be stored in a memory 44 of the monitor 40 for ready access by the processor 42, also included as a component of the monitor. As a further option, coding of multiple characters may be stored in the memory 44 with functionality provided, such as via an on-screen user accessible menu, to allow a user to select among the available characters for animation in window 52. For example, if a children's program is being viewed, a child-appropriate character, (e.g. a cartoon character, etc.) may be selected by the user. Such a selection may also be automatic by the processor 42 via the processor identifying the currently received program by, for example, station identification techniques, (e.g. watermarks, etc.) to select an appropriate character 54 for animation.

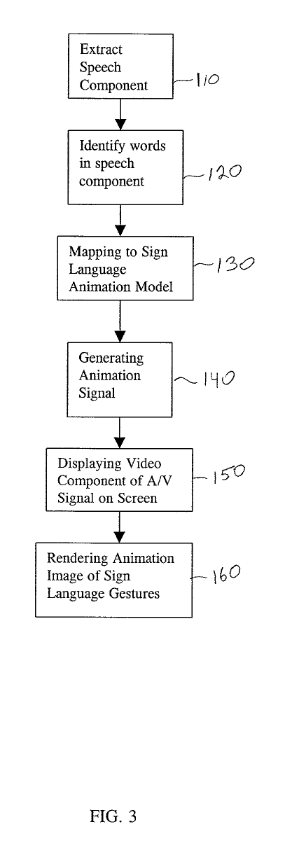

Turning now to FIG. 3, a method in accordance with the present invention will now be described. As shown, the speech component of the audio signal from an A/V signal is extracted using, for example, the techniques referred to above (step 110). Thereafter, spoken words from the extracted speech component are identified (step 120) and the spoken words are then mapped to a sign language animation model (step 130) to identify the sign language gestures corresponding to the spoken words and to produce the necessary animation model parameters. Thereafter, an animation signal is generated (140) such as by accessing appropriate coding associated with a selected character icon stored in a memory of the monitor/receiver 40 (step 140), whereupon an animation image of sign language gestures is rendered on the monitor display screen, and in particular, in the designated sign window 52 (step 160). Simultaneously with, before or after executing step 160, the video component of the A/V signal will also be displayed on the monitor display screen, and, in particular, on the main screen portion 50 (step 150).

It is pointed out that the method shown in FIG. 3 and described above as well as the system depicted in FIG. 1 is flexible with regard to the location of the processing and extraction commands, devices or techniques employed in generating the animation model parameters used for rendering the animation video signal or stream via use of the character icon 54. In particular, and in the case of a television broadcast signal transmitted from a television station remotely located from the monitor/receiver 40, a processor located at the television transmitter may be used to isolate the speech signal, identify the spoken words contained therein and generate corresponding animation parameters, such as by accessing a sign language look-up table in communication with a television signal transmitter processor. Then, the television A/V signal can be transmitted to intended viewers, in various known manners, along with the non-video signal containing the generated animation models parameters. In this manner, only a limited amount of bandwidth need be employed for the animation model parameters as opposed to that which would be needed for a separate animation video stream or signal. Once the animation model parameters are received by the monitor/receiver 40, the processor 42 will then execute the necessary animation rendering and display the animation signal in the sign window 52.

Alternatively, a television A/V signal can be received by the monitor/receiver 40 and then used to generate the animation model parameters via use of processor 42, such as by isolating the speech component from the audio signal, identifying the spoken words, mapping the spoken words to sign language gestures, etc. Although either technique can be used, i.e. processing at the broadcast transmitter station or processing at the receiver/monitor device 40, it will be appreciated that the former technique will employ less computational power in the monitor processor 42.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of displaying, on a monitor having a display screen, a sign language animation of a speech component of an audio/video signal while simultaneously displaying, on the monitor display screen, a visual image corresponding to a video component of the audio/video signal, comprising the steps of:
mapping the speech component to a sign language animation model to generate animation model parameters corresponding to sign language images;
generating an animation signal from said animation model parameters by using a processor connected to the monitor; and
rendering, from said animation signal, an animation image on a portion of the monitor, said animation image containing sign language gestures corresponding to the speech component of the audio/video signal.

2. The method of claim 2, further comprising the step of receiving, before performing said mapping step, the audio/video signal at the monitor, and isolating the speech component from the audio/video signal, wherein said isolating step is performed by the processor.

3. The method of claim 1, wherein the audio/video signal is provided to the monitor by a transmitter remotely located from the monitor, and wherein said mapping step is performed remotely from the monitor.

4. The method of claim 3, wherein the mapping step is performed proximate the transmitter.

5. The method of claim 4, further comprising the step of transmitting the animation model parameters to the monitor.

6. The method of claim 1, wherein the processor comprises a memory containing data for multiple character icons and wherein said animation image is rendered by animating a select one of the multiple character icons.

7. The method of claim 1, wherein the processor is activated by selecting a function on a monitor control device.

8. The method of claim 6, wherein the select one character icon includes a face having a mouth and wherein said animation image further comprises the step of animating the mouth to simulate speech corresponding to the speech component of the audio/video signal.

9. The method of claim 6, wherein said memory includes commands corresponding to a dictionary of sign language symbols and wherein said mapping step comprises correlating spoken words from the speech signal to the sign language symbols.

10. The method of claim 1, wherein Synthetic Natural Hybrid Coding (SNHC) is used to generate the animation model parameters.

11. A method of displaying, on a monitor having a display screen, a sign language animation of a speech component of an audio/video signal while simultaneously displaying, on the monitor display screen, a visual image corresponding to a video component of the audio/video signal, comprising the steps of:
isolating the speech component from an audio component of the audio/video signal;
identifying words represented by the isolated speech component;
mapping the identified words to a sign language animation model to generate animation model parameters corresponding to sign language images;
transmitting the audio/video signal and the animation model parameters to the monitor;
receiving the transmitted audio/video signal at the monitor;
generating an animation signal from said animation model parameters by using a processor connected to the monitor;
displaying a video component of the audio/video signal on the monitor display screen; and
rendering, from said animation signal, an animation image on a portion of the monitor display screen, said animation image containing sign language gestures corresponding to the speech component of the audio/video signal.

12. The method of claim 11, wherein the processor comprises a memory containing data for multiple character icons and wherein said animation image is rendered by animating a select one of the multiple character icons.

13. The method of claim 11, wherein the processor is activated by selecting a function on a monitor control device.

14. The method of claim 12, wherein the select one character icon includes a face having a mouth and wherein said animation image further comprises the step of animating the mouth to simulate speech corresponding to the speech component of the audio/video signal.

15. The method of claim 11, wherein said memory includes commands corresponding to a dictionary of sign language symbols and wherein said mapping step comprises correlating spoken words from the speech signal to the sign language symbols.

16. The method of claim 11 wherein Synthetic Natural Hybrid Coding (SNHC) is used to generate the animation model parameters.

17. A system for producing an animation image on a monitor display screen to display, to a viewer of the monitor, sign language gestures corresponding to a speech signal derived from an audio signal component of an audio/video signal, the system comprising:
a transmitter for transmitting the audio/video signal to the monitor;
a receiver connected to the monitor for receiving the transmitted signal;
a memory connected to the monitor for storing sign language animation model parameters corresponding to at least one animation character icon;
a processor connected to the receiver and to the memory for isolating the speech signal from the audio signal component of the transmitted audio/video signal, the processor comprising means for identifying words represented by the isolated speech signal and means for mapping the identified words to the sign language animation model parameters for generating an animation signal; and
means for rendering the animation image on the monitor using the animation signal to animate the at least one animation character icon.

18. The system of claim 17, wherein said mapping means comprises Synthetic Natural Hybrid Coding (SNHC).

19. The system of claim 17, wherein the processor comprises a memory containing data for multiple character icons and wherein said animation image is rendered by animating a select one of the multiple character icons.

20. The system of claim 19, wherein the select one character icon includes a face having a mouth and wherein said animation image further comprises the step of animating the mouth to simulate speech corresponding to the speech component of the audio/video signal.

21. The system of claim 19, wherein said memory includes commands corresponding to a dictionary of sign language symbols and wherein said mapping means comprises means for correlating spoken words from the speech signal to the sign language symbols.

22. A system for producing an animation image on a monitor display screen to display, to a viewer of the monitor, sign language gestures corresponding to a speech signal derived from an audio signal component of an audio/video signal, the system comprising:
a transmitter processor for isolating the speech signal from the audio signal component of the audio/video signal, the processor comprising means for identifying words represented by the isolated speech signal and means for mapping the identified words to a sign language animation model for generating animation model parameters corresponding to sign language images;
a transmitter for transmitting the audio/video signal and the animation model parameters to the monitor;
a receiver connected to the monitor for receiving the transmitted signal and animation model parameters;
a memory connected to the monitor for storing an animation model of at least one animation character icon;
a receiver processor for generating an animation signal from the animation model parameters for animating the at least one character icon; and
means for rendering the animation image on the monitor using the animation signal to animate the at least one animation character icon.

23. The system of claim 22, wherein said transmitter processor is capable of accessing commands corresponding to a dictionary of sign language symbols and wherein said mapping means comprises means for correlating spoken words from the speech signal to the sign language symbols.

24. The system of claim 22, wherein said mapping means comprises Synthetic Natural Hybrid Coding (SNHC).
